(19) United States
(12) Patent Application Publication
(10) Pub. No.: US 2005/0269960 A1
(43) Pub. Date: Dec. 8, 2005

(54) Display with current controlled light-emitting device

(75) Inventors: Shinya Ono, Kanagawa (JP); Koichi Miwa, Kanagawa (JP); Yoshinao Kobayashi, Kanagawa (JP)

Correspondence Address: BIRCH STEWART KOLASCH & BIRCH, PO BOX 747, FALLS CHURCH, VA, 22040-0747, US

(73) Assignees: Kyocera Corporation; Chi Mei Optoelectronics Corp.

(21) Appl. No.: 11/144,662

(22) Filed: Jun. 6, 2005

(30) Foreign Application Priority Data
Jun. 7, 2004 (JP) 2004-168783

(51) Int. Cl. G09G 3/10

(52) U.S. Cl. 315/169.3

(57) ABSTRACT

A display includes an electric current controlled light-emitting device that emits light with a luminance depending on an electric current flowing therethrough. The display also includes a transistor that has a gate electrode, a source electrode, and a drain electrode, and controls the electric current based on a data voltage between one of the source and drain electrodes and the gate electrode; and a controller that controls a gate-to-source voltage and a gate-to-drain voltage of the transistor based on a change in the luminance of the electric current controlled light-emitting device while maintaining the transistor element in a saturation region.

### BACKGROUND OF THE INVENTION

1. Field of the Invention

The present invention relates to a display which includes an electric current controlled light-emitting device, which emits light according to a desired gradation level, and a thin film transistor, which controls an amount of electric current flowing into the electric current controlled light-emitting device.

2. Description of the Related Art

An organic electroluminescence (EL) display, which employs an organic light-emitting diode (OLED) as a self-luminous device, does not need a backlight which is usually required in liquid crystal displays. Hence, the organic EL display is particularly suitable for flat screen displays. In addition, the viewable angle of the organic EL display has no constraint. Thus, the practical application of the organic EL display is being waited for as a display of the next generation that will replace the liquid crystal displays.

Known displays using the organic EL devices can be classified into a passive matrix type and an active matrix type. The former, though being advantageous in its structural simplicity, has difficulties in realizing a large high-definition display. Hence, in recent years there has been a growing interest in the development of the active matrix type displays which control the electric current flowing through the OLEDs in the pixels by an active device provided also in the pixel, e.g., a driver including a thin film transistor (see, for example, Japanese Patent Application Laid-Open No. 2002-196357).

Known materials for the channel region of the thin film transistor which serves as the driver are polycrystalline silicon and amorphous silicon, for example. The polycrystalline silicon thin film transistor has a high carrier mobility but has difficulties controlling grain size of the polycrystalline silicon forming the channel layer. The carrier mobility of the thin film transistor formed of polycrystalline silicon is affected by the grain size of the polycrystalline silicon of the channel layer. Hence, the difficulties controlling the grain size result in different carrier mobilities of the thin film transistor in different pixels. For example, assume that the same gate voltage is applied to thin film transistors constituting respective pixels so that a single color is displayed on the entire screen. Since the grain size control of the thin film transistor of polycrystalline silicon is difficult, the carrier mobility may differ from pixel to pixel, whereby the current flowing through the organic EL devices varies. Since the organic EL device is an electric current controlled light-emitting device, the luminance of each pixel depends on the amount of the current flowing therethrough. As a result, the display of a single color is unachievable.

On the other hand, for the thin film transistor with the channel layer made of amorphous silicon, the grain size control is not necessary, and the carrier mobility of a thin film transistor provided for each pixel does not vary. Hence, the thin film transistor with a channel layer of amorphous silicon is more preferable as the driver of the organic EL device. The thin film transistor of such structure allows substantially same amount of current to flow in respective organic EL devices.

However, a conventional image display which employs the thin film transistor with an amorphous silicon channel layer as the driver cannot perform an image display for a long time period. The thin film transistor with amorphous silicon, when subjected to a long-time current flow on the channel layer, is known to cause changes in threshold voltage over time. This is because the amount of current flowing through the channel layer changes according to the changes in the threshold voltage even under a constant gate voltage.

For example, it is known that when the current is successively applied to the organic EL device in the conventional display so that the organic EL device emits light with a luminance of 150 cd/m², the change in the threshold voltage in 2000 hours doubles that in approximately 100 hours. In general, the display using the organic EL device is required to maintain a constant luminance approximately for 20000 hours without cease and significant change in the threshold voltage in a short time period is not preferable.

### SUMMARY OF THE INVENTION

A display according to one aspect of the present invention includes an electric current controlled light-emitting device that emits light with a luminance depending on an electric current flowing therethrough. The display also includes a transistor that has a gate electrode, a source electrode, and a drain electrode, and controls the electric current based on a data voltage between one of the source and drain electrodes and the gate electrode; and a controller that controls a gate-to-source voltage and a gate-to-drain voltage of the transistor based on a change in the luminance of the electric current controlled light-emitting device while maintaining the transistor element in a saturation region.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of an overall structure of a display according to a first embodiment of the present invention;

FIG. 2 is a schematic diagram shown to describe a relation between a reference voltage and a data voltage generated by a data-line driver circuit;

FIG. 3 is a graph of changes in a driving threshold voltage during continuous drive of a thin film transistor;

FIG. 4 is a circuit diagram of a specific example of a controller provided in the display;

FIG. 5 is a circuit diagram of another specific example of a controller provided in the display;

FIG. 6 is a schematic diagram of an overall structure of a display according to a second embodiment; and

FIG. 7 is a timing chart of variations in potential in some signal lines in the display according to the second embodiment.

### DETAILED DESCRIPTION OF THE PREFERRED EMBODIMENTS

Exemplary embodiments of a display according to the present invention will be described below with reference to the accompanying drawings. The drawings should be understood as being exemplary only and different from an actual structure. The relation between and ratio of the elements shown in the drawings may differ in each drawing. Hereinbelow, when an electrode structure other than a gate electrode in a thin film transistor can function either as a source electrode or a drain electrode, such structure is referred to as a source/drain electrode. Though the present invention is described below as applied to a thin film transistor of an n-channel type, the present invention is surely applicable to a p-channel transistor as well.

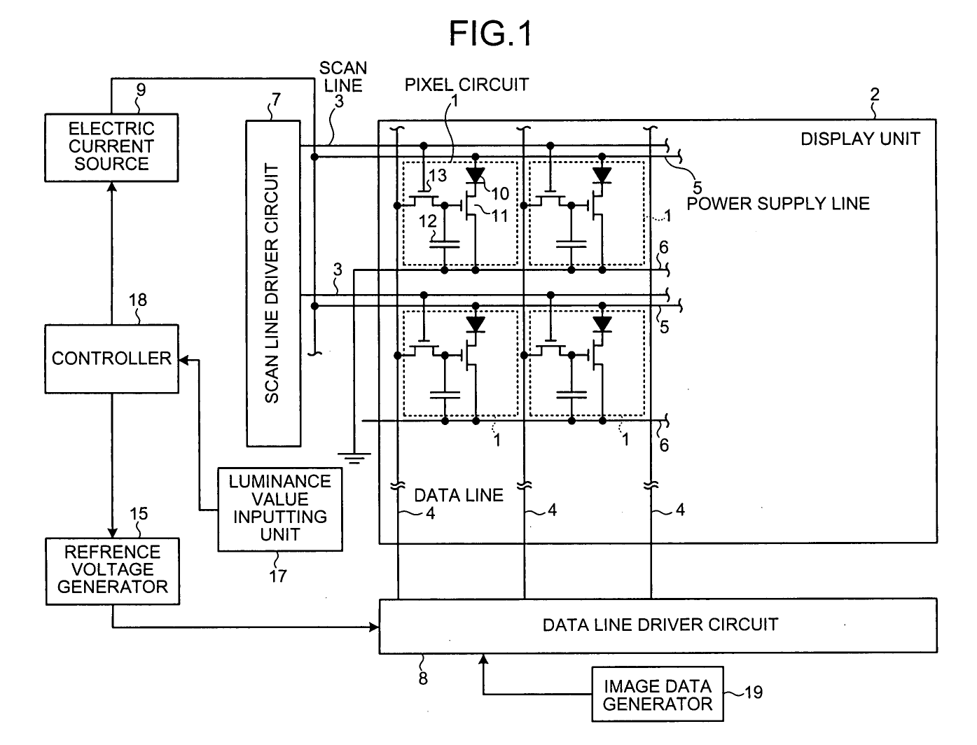

A display according to a first embodiment will be described. FIG. 1 is a schematic diagram of an overall structure of the display according to the first embodiment. As shown in FIG. 1, the display according to the first embodiment includes a display unit 2 that is provided with a plurality of pixel circuits 1 arranged in a matrix (hereinafter each pixel circuit is also referred to as “pixel circuit 1”), a plurality of scan lines 3 which extend along a column direction of the matrix formed by the pixel circuits 1 and provide predetermined scan signals respectively to the pixel circuits 1 in a same row, a plurality of data lines 4 that extend in a row direction of the matrix formed by the pixel circuits 1 and provide predetermined display signals respectively to the pixel circuits 1 in a same column, a power supply line 5 that provides electric currents to the pixel circuits 1, and an electric current discharging line 6 that discharges the electric currents charged into the pixel circuits 1. Further, the display according to the first embodiment includes a scan-line driver circuit 7 which is connected to the scan line 3 and generates the scan signal to be supplied via the scan line 3, and a data-line driver circuit 8 which is connected to the data line 4 and generates the display signal to be supplied via the data line 4.

The pixel circuits 1 are arranged in a matrix and collectively serve to display an image by emitting light with a luminance corresponding to a gradation level. Each pixel circuit 1 corresponds to a pixel (e.g., sub pixel R(red), G(green), or B(blue) when the display exhibits the image in colors), and specifically, includes an electric current controlled light-emitting device 10 that emits light with a luminance depending on received current, and a thin film transistor 11 having a drain electrode connected to a cathode side of the electric current controlled light-emitting device 10 and a source electrode connected to the current discharging line 6, and controlling an amount of electric currents flowing to the electric current controlled light-emitting device 10. Further, the pixel circuit 1 includes a condenser 12 arranged between the gate and the source of the thin film transistor 11 and a thin film transistor 13 having a gate electrode connected to the scan line 3, one source/drain electrode connected to the data line 4, and another source/drain electrode connected to the gate electrode of the thin film transistor 11.

The electric current controlled light-emitting device 10 has a function of emitting light with a luminance depending on the amount of received electric current. The electric current controlled light-emitting device 10 is formed, for example, of an organic EL device. More specifically, the electric current controlled light-emitting device 10 is structured with an anode layer, a light emitting layer, and a cathode layer provided in this order. The light emitting layer serves to recombine electrons injected from the side of the cathode layer and positive holes injected from the side of the anode layer to emit light. Specifically, the light emitting layer is made of an organic material, such as phthalcyanine, tris-aluminum complex, benzoquinolinolato, beryllium complex, and predetermined impurity is added to the structure as necessary. Here, if the organic EL device is employed as the electric current controlled light-emitting device 10, a positive hole transport layer may be provided on the anode side of the light emitting layer, and an electron transport layer may be provided on the cathode side of the light emitting layer.

The thin film transistor 11 has a function to control the amount of electric current flowing through the electric current controlled light-emitting device 10 as a result of application of a voltage corresponding to the gradation level to the gate electrode. Though the thin film transistor 11 may have any structure, a thin film transistor with an amorphous silicon channel region is employed in the first embodiment in view of an advantage of little fluctuation in electric characteristic in each of plural pixel circuits 1 and the like.

The thin film transistor 13 is driven by a voltage applied from the scan line 3. The thin film transistor 13 has a function of controlling conduction between the gate electrode of the thin film transistor 11 and the data line 4 according to the voltage applied from the scan line 3. Here a specific structure of the thin film transistor 13 is same with that of the thin film transistor 11.

The scan-line driver circuit 7 serves to control the drive of the thin film transistor 13 provided in the pixel circuit 1 via the scan line 3. Specifically, the scan-line driver circuit 7 has a function of providing a sufficient voltage for driving the thin film transistor 13 sequentially to each of the plural scan lines 3 each correspond to a row in the matrix of the pixel circuits 1.

The data-line driver circuit 8 serves to provide a voltage corresponding to the gradation level to the thin film transistor 11 provided in the pixel circuit 1 via the data line 4. Specifically, the data-line driver circuit 8 generates a voltage to be supplied to the thin film transistor 11 provided-in each of the pixel circuit 1 based on image data generated by an image data generator 19 external to the display, and a reference voltage generated by a reference voltage generator 15 described later. Here, the voltage actually supplied by the data-line driver circuit 8 in the first embodiment is a sum of a data voltage V_{data} corresponding to the gradation level and a driving threshold voltage Vₜₕ so that the driving threshold voltage of the thin film transistor 11 is taken into account.

In addition, the display according to the first embodiment includes an electric current source 9 which supplies necessary currents for light emission by the electric current controlled light-emitting device 10 via the power supply line 5, the reference voltage generator 15 which generates a reference voltage to be employed for determination of data voltage V_{data} supplied from the data-line driver circuit 8, and a luminance value inputting unit 17 which serves to input specific value(s) of display luminance for the entire display unit 2. Further, the display according to the first embodiment is provided with a controller 18 which performs functions such as determining the value of an electric current source voltage V_{DD} to be applied to the anode side of the electric current controlled light-emitting device 10 when the electric current source 9 supplies electric currents and a reference voltage V_{ref} which is generated by the reference voltage generator 15.

The electric current source 9 applies a predetermined level of voltage to the cathode of the electric current controlled light-emitting device 10 via the power supply line 5 to generate a predetermined potential difference between the cathode and the anode of the electric current controlled light-emitting device 10, and create an electric current flow to the electric current controlled light-emitting device 10 based on the potential difference. Further, the electric current source 9 has a function of changing the value of the electric current source voltage V_{DD} to be supplied to the anode side of the electric current controlled light-emitting device 10 under the control by the controller 18 as described below.

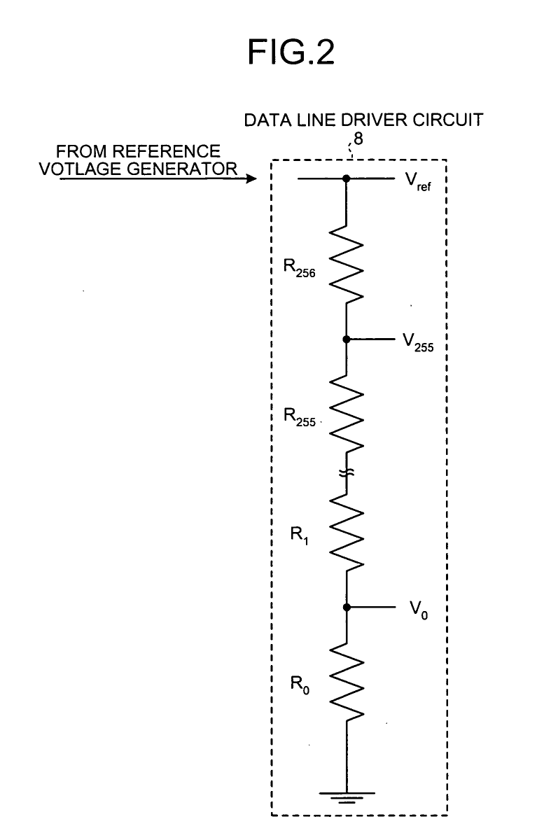

The reference voltage generator 15 serves to generate and output the reference voltage according to the display luminance of the entire display unit 2. The relation between the reference voltage and the data voltage generated by the data-line driver circuit 8 will be described briefly. FIG. 2 is a schematic diagram showing this relation. As shown in FIG. 2, the data-line driver circuit 8 is structured with electric resistances R₀-R₂₅₆ connected in series and this series-connected structure has one end connected to the ground and another end formed as to receive reference voltage V_{ref} generated by the reference voltage generator 15.

Further, voltages V₀-V₂₅₅ in FIG. 2 indicate the levels of data voltage V_{data} corresponding to gradation level 0-255, respectively. In other words, data voltage V_{data} generated by the data-line driver circuit 8 is determined by the division of reference voltage V_{ref} supplied from the reference voltage generator 15. Hence, the absolute values of data voltage V_{data} vary according to specific values of reference voltage V_{ref} even when the display of an image of the uniform gradation is intended. With the changes in reference voltage V_{ref} according to the display luminance or the like of the entire display unit 2, the absolute value of the data voltage V_{data} also changes.

The luminance value inputting unit 17 serves to accept a value of luminance for the entire display unit 2. Specifically, the luminance value inputting unit 21 may be structured as to be capable of receiving a numerical value corresponding to desired luminance designated by a user, or may be structured as to automatically derive a proper luminance according to the changes in driving condition such as power consumption.

The controller 18 has the functions such as controlling the driving conditions or the like of respective elements of the display according to the first embodiment, determining specific levels of the electric current source voltage V_{DD} supplied from the electric current source 9 and the reference voltage V_{ref} supplied from the reference voltage generator 15 according to the specific value of luminance supplied from the luminance value inputting unit 17, to control the electric current source 9 or the like as to supply the voltage of the determined level. More particularly, the controller 18 derives the electric current source voltage V_{DD} and the reference voltage V_{ref} so as to suppress the fluctuation in the driving threshold voltage of the thin film transistor 11 which functions as a driver and is arranged for each pixel circuit 1.

Next, a mechanism to determine the electric current source voltage V_{DD} and the reference voltage V_{ref} derived by the controller 18 in the display according to the first embodiment will be described. In the first embodiment, a standard electric current source voltage and a standard reference voltage are derived which are necessary for constant driving of the thin film transistor 11 in the saturation region at a predetermined standard luminance. The controller 18, based on such standard electric current source voltage or the like, derives the electric current source voltage or the like for a predetermined luminance and directs the electric current source 9 and the reference voltage generator 15 so as to supply voltage of the derived level. Hereinafter, first an example of the mechanism to derive the standard electric current source voltage and the standard reference voltage where a lowest luminance (hereinafter referred to as the “lowest luminance”) which can be displayed on the entire display unit 2 is employed as the standard luminance will be described followed by the description of the derivation of the electric current source voltage or the like at an optional luminance using the standard electric current source voltage. For the simplicity of description, the electric characteristics of the electric current controlled light-emitting device 10 and the thin film transistor 11 or the like in each pixel are assumed to be same regardless of the difference in pixels, and that the electric characteristics of the thin film transistor 11 or the like do not change over time.

First, values to be employed in the description of the mechanism to determine the electric current source voltage or the like will be described. Maximum luminance and minimum luminance which are guaranteed on the entire display unit 2 will be denoted respectively by reference characters L_{max,max} and L_{max,min}. The values of such luminance may be determined based on a specific structure of the display or may be set according to the quality of the product guaranteed by the manufacturer.

Provided that the display luminance of the entire screen is L_{max,max}, the supplied data voltage and the voltage applied to the electric current controlled light-emitting device 10 at a display under such condition are denoted respectively by V_{data,max,max,z} (Z=R, G, B), and V_{OLED,max}. Further, the level of the electric current source voltage when the display is given in the lowest luminance L_{max,min} is denoted by V_{DDmin}, and the data voltage supplied to the pixel circuit 1 which provides display in the lightest gradation under the lowest luminance condition is denoted as V_{data,max,min,z} (Z=R, G, B). Further, the level of the reference voltage in the lowest luminance L_{max,min} display is denoted as V_{ref,max,min}.

With these values, first, a condition to drive the thin film transistor 11 in the saturation region is found, on the assumption that the luminance of the entire display unit 2 is the lowest luminance L_{max,min}. The source electrode of the thin film transistor 11 is connected to the ground, i.e., to zero potential, whereas the drain electrode thereof is electrically connected to the electric current source 9 via the electric current controlled light-emitting device 10. Hence, the drain-to-source voltage V_{ds} is defined with the potential V_{DD} supplied from the electric current source 9 and the voltage V_{OLED} applied to the electric current controlled light-emitting device 10 as
V_{ds}=V_{DD}−V_{OLED} (1).
The value of V_{ds} at the lowest luminance L_{max,min} has a relation with a lowest level V_{DDmin} of the potential V_{DD} supplied from the electric current source 9 and a highest level V_{OLED,max} of the voltage V_{OLED} applied to the electric current controlled light-emitting device 10, which can be defined as:
V_{ds}≧V_{DDmin}−V_{OLED,max} (2).
In other words, the electric current source voltage at the lowest luminance L_{max,min} can be given by V_{DDmin} described above. The applied voltage V_{OLED}, which changes according to the amount of the received current, always at a lower level than the level of V_{OLED,max}. Hence, V_{ds} at the lowest luminance L_{max,min} always satisfies Expression (2). In Expression (2), the value at the maximum luminance L_{max,max} is employed instead of the maximum level of V_{OLED} at the lowest luminance L_{max,min}. The reason will be described later.

On the other hand, the source electrode of the thin film transistor 11 is maintained at the ground level (zero potential). Then, the gate-to-source voltage V_{gs} of the thin film transistor 11 can be represented with the data voltage V_{data} supplied from the data-line driver circuit 8 and the driving threshold voltage Vₜₕ of the thin film transistor 11 as
V_{gs}=αV_{data}+Vₜₕ (3)
where the coefficient α is referred to as a circuit parameter, which represents the ratio of the voltage supplied from the data-line driver circuit 8 to the voltage actually applied to the gate electrode of the thin film transistor 11 corresponding to such voltage. Since the driving threshold Vₜₕ of the thin film transistor is also supplied from the data-line driver circuit 8 in the first embodiment, to be strict, α should be multiplied to the second term of the right-hand side of Expression (3). Here, to facilitate the understanding, it is assumed that the data-line driver circuit 8 supplies voltage at the level of (Vₜₕ/α) as the driving threshold voltage in advance whereby the gate electrode of the thin film transistor 11 receives voltage Vₜₕ.

The maximum level of the gate-to-source voltage V_{gs} in the lowest luminance L_{max,min} of the entire screen will be derived. If the driving threshold voltage Vₜₕ is a constant, as is clear with reference to Expression (3), when the data voltage V_{data} takes a maximum level, the V_{gs} also attains a maximum level. In other words, the following Expression (4) holds;
V_{gs}≦αV_{data,max,min}+Vₜₕ (4)
where V_{data,max,min} represents a data voltage at the time the display is given in the lightest gradation with the lowest luminance L_{max,min} (i.e., at the time a highest data voltage at the lowest luminance L_{max,min} is provided). Further, as shown in FIG. 2, since the data voltage V_{data} is given as the division of the reference voltage V_{ref}, the following relation stands between the reference voltage V_{ref,min} at the lowest luminance L_{max,min} and V_{data,max,min}.
V_{ref,min}≧V_{data,max,min} (5)

To drive the thin film transistor 11 in the saturation region, a predetermined relation needs to hold between the gate-to-source voltage V_{gs} and the drain-to-source voltage V_{ds}. When
V_{ds}≧V_{gs}−Vₜₕ (6)
stands, the thin film transistor 11 is driven in the saturation region.

Hence, to drive the thin film transistor 11 in the saturation region at the lowest luminance L_{max,min}, the values of the electric current source voltage V_{DDmin} and the reference voltage V_{ref,min} to be used at the lowest luminance L_{max,min} must be set so that the values of V_{ds} and V_{gs} as represented by Expressions (1) to (4) always satisfy Expression (6). In particular, at the lowest luminance L_{max,min}, the electric current source voltage V_{DDmin} and the reference voltage V_{ref,min} are determined so as to satisfy the expression
V_{DDmin}−V_{OLED,max}≧αV_{ref,min} (7)
The right-hand side of Expression (7) represents the lower limit of the electric current source voltage V_{DDmin} as is clear from Expression (2). The right-hand side of Expression (7) represents the upper limit of the difference between the gate-to-source voltage V_{gs} and the driving threshold voltage shown by the right-hand side of Expression (6), as is clear from the fact that the right-hand side of Expression (7) can be represented as
αV_{ref,min}≧αV_{data,max,min}≧V_{gs}−Vₜₕ (8)
based on Expressions (4) and (5). Hence, at the lowest luminance L_{max,min}, the thin film transistor 11 can be always driven in the saturation region if the electric current source voltage V_{DDmin} and the reference voltage V_{ref,min} are determined so as to satisfy Expression (7). Thus, the values of the standard electric current source voltage (i.e., electric current source voltage V_{DDmin}) and the standard reference voltage (i.e., reference voltage V_{ref,min}) when the lowest luminance is the reference luminance are set.

Next, based on the standard electric current source voltage and the standard reference voltage as derived, the mechanism for deriving the values of electric current source voltage V_{DD} and the reference voltage V_{ref} which allow the constant driving of the thin film transistor 11 in the saturation region at any display luminance will be described. When the entire screen has the luminance lighter than the lowest luminance L_{max,min}, in general the amount of the electric current flowing to the electric current controlled light-emitting device 10 needs to be larger compared with the amount at the time of lowest luminance L_{max,min}. Hence, the electric current source voltage V_{DD} and the reference voltage V_{ref} also attain higher levels than V_{DDmin} and V_{ref,min}, respectively, according to the increase in the display luminance L.

When the electric current source voltage V_{DD} and the reference voltage V_{ref} are increased at discretion, however, the thin film transistor 11 may deviate from the saturation region to be driven in a linear region. Hence, in the first embodiment, the controller 18 derives values such as V_{DD} so as to satisfy the condition shown by Expression (7) with respect to the electric current source voltage V_{DD} and the reference voltage V_{ref} at a predetermined luminance L (L_{max,min}≦L≦L_{max,max}).

When a predetermined differential voltage ΔV is added to both sides of Expression (7), the relation
V_{DDmin}−V_{OLED,max}+ΔV≧αV_{ref,min}+ΔV (9)
holds, maintaining the inequality sign of Expression (7). Then, when both sides of Expression (9) are rearranged, the following Expression (10) stands:
(V_{DDmin}+ΔV)−V_{OLED,max}≧α{V_{ref,min}+(ΔV/α)} (10)
Here, if the electric current source voltage V_{DD} and the reference voltage V_{ref} are defined as
V_{DD}=V_{DDmin}+ΔV (11)
V_{ref}=V_{ref,min}+(ΔV/α) (12)
as is clear from Expression (10), V_{DD} and V_{ref} satisfy the relation of the inequality of (7). Since Expression (7) is a condition for driving the thin film transistor 11 always in the saturation region, when the electric current source voltage V_{DD} and the reference voltage V_{ref} are defined respectively by Expressions (11) and (12), the thin film transistor 11 is always driven in the saturation region.

Hence in the first embodiment, the controller 18, based on the luminance information supplied from the display luminance value inputting unit 17, derives a specific value of the differential voltage ΔV corresponding to the difference between the received luminance and the lowest luminance, for example, and calculates Expressions (11) and (12) with the derived value of the differential voltage ΔV to derive the electric current source voltage V_{DD} and the reference voltage V_{ref}. Then, the controller 18 directs the electric current source 9 and the reference voltage generator 15 to supply a specific level of the derived electric current source voltage or the like, and the electric current source 9 or the like supply the voltage according to the direction.

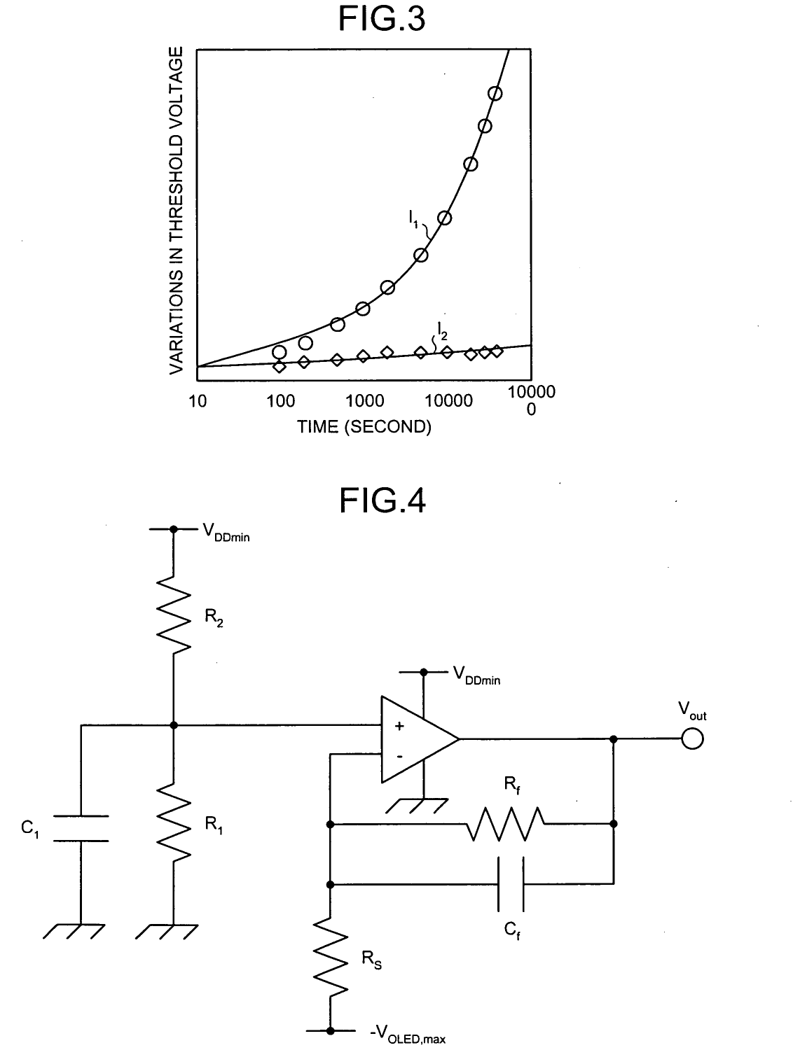

Next, an advantage of driving the thin film transistor 11 in the saturation region will be described. FIG. 3 is a graph showing a comparison of the variation of threshold over time when the thin film transistor of the same structure operates in the saturation region and in the linear region. In FIG. 3, a curve l₁ represents the operation of the thin film transistor in the linear region whereas a curve l₂ represents the operation of the thin film transistor in the saturation region.

As shown in FIG. 3, when the thin film transistor operating in the saturation region (curve l₂) is compared with the thin film transistor operating in the linear region (curve l₁), the fluctuation in the threshold voltage clearly decreases. For example, when compared at hundred thousand (100,000) seconds from the beginning, the fluctuation in the threshold voltage in the operation in the saturation region is not more than one tenth that in the operation in the linear region. Thus, the fluctuation in the threshold voltage can be suppressed when the thin film transistor 11 operates in the saturation region.

On the other hand, the gate voltage and the drain voltage of the thin film transistor 11 vary according to the gradation level in each display pixel and the display luminance of the entire display unit 2. Hence in the first embodiment, the electric current source voltage V_{DDmin} and the reference voltage V_{ref,min} which satisfy Expression (7) are derived in advance as reference values, and the controller 18 determines the value of ΔV according to the changes in the display luminance and derives the electric current source voltage V_{DD} and the reference voltage V_{ref} corresponding to the display luminance based on Expressions (11) and (12) and appropriate for the driving of the thin film transistor 11 in the saturation region.

Hence, in the display according to the first embodiment, the thin film transistor 11 which serves as the driver is always driven in the saturation region regardless of the changes in the display luminance on the entire screen. As shown in FIG. 3, compared with the conventional display, the display according to the embodiment is advantageous since the fluctuation of the driving threshold voltage of the driver can be suppressed and the high-resolution image display as well as the long life of the display can be realized.

In the first embodiment, the standard values of the electric current source voltage and the reference voltage are derived under the condition of the lowest luminance L_{max,min}. As is clear from the foregoing, however, the luminance at the standard value derivation is not limited to the lowest luminance L_{max,min}. Since Expression (7) is derived with the maximum value of the voltage applied to the electric current controlled light-emitting device 10, i.e., V_{OLED,max}, Expression (7) can be employed as a conditional expression not only for the lowest luminance L_{max,min} but also for the driving of the thin film transistor 11 in the saturation region for any value of luminance L. Hence, the electric current source voltage and the reference voltage which satisfy Expression (7) at the display luminance other than the lowest luminance may be employed as the standard electric current source voltage and the standard reference voltage instead of V_{DDmin} and V_{ref,min}, and the differential voltage ΔV may be determined based on the difference between the display luminance other than the lowest luminance mentioned above and the received luminance.

Further, in the above example, the standard electric current source voltage and the standard reference voltage are set in advance. The standard electric current source voltage and the standard reference voltage, however, may be derived in the controller 18. FIG. 4 is a circuit diagram of a structure of a circuit that generates the standard reference voltage based on the standard electric current source voltage. In the circuit shown in FIG. 4, with the input of V_{DDmin} (standard electric current source voltage) and −V_{OLED,max} as shown, the following expression holds for an output Vₒᵤₜ:
Vₒᵤₜ=−V_{OLED,max}+{(R_{f}+Rₛ)/Rₛ}{R₁/(R₁+R₂){V_{DDmin} (13)
Here, if the value of each electric resistance in the circuit shown in FIG. 4 is determined in advance as to satisfy the following Expression (14):
R_{f}/Rₛ=R₂/R₁ (14),
the coefficient of V_{DDmin} in the right-hand side of Expression (13) is one. Then, if
Vₒᵤₜ=V_{ref,min} (15),
Expression (13) also stands as an expression for generating the standard reference voltage based on the standard electric current source voltage. Such derivation does not contradict with Expression (7). The circuit parameter a is determined according to the attenuation of intensity of the potential supplied from the data-line driver circuit 8 and does not take a value larger than one. Hence, V_{ref,min} derived based on Expressions (13) to (15) clearly satisfies Expression (7).

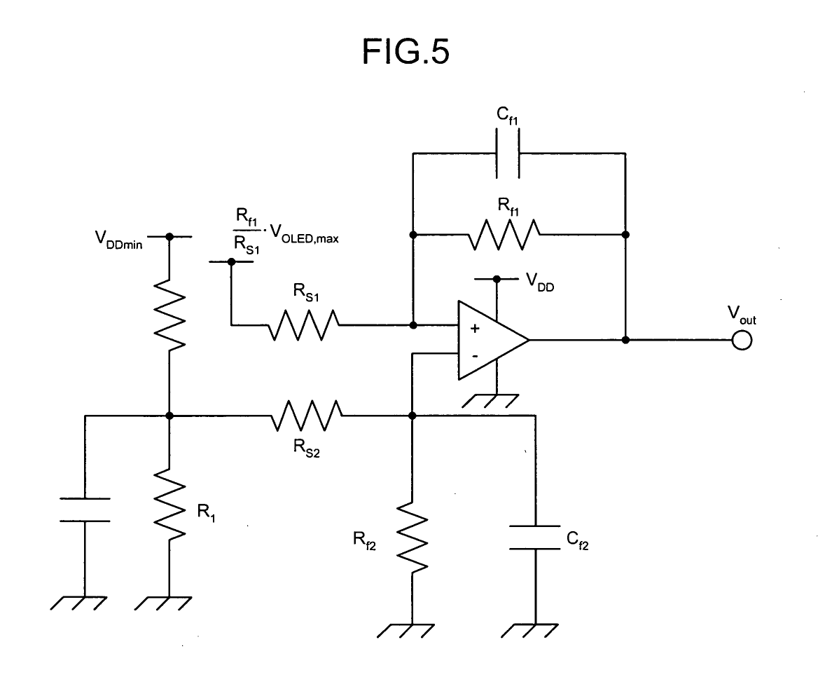

Similarly, a circuit shown in FIG. 5 can be employed. In the circuit of FIG. 5, when Vₒᵤₜ is determined in advance for each electric resistance so as to satisfy:
R_{f1}/Rₛ₁=R_{f2}/Rₛ₂=(R₁+R₂)/R₁ (16),
the relation:
Vₒᵤₜ=V_{DDmin}−V_{OLED,max} (17)
is derived. In this case, Vₒᵤₜ can be employed in place of V_{ref,min}.

Next, a display according to a second embodiment will be described. The display according to the second embodiment includes in the pixel circuit a threshold voltage adder which applies the driving threshold voltage of the thin film transistor 11 to received data voltage, in addition to the structure of the display according to the first embodiment.

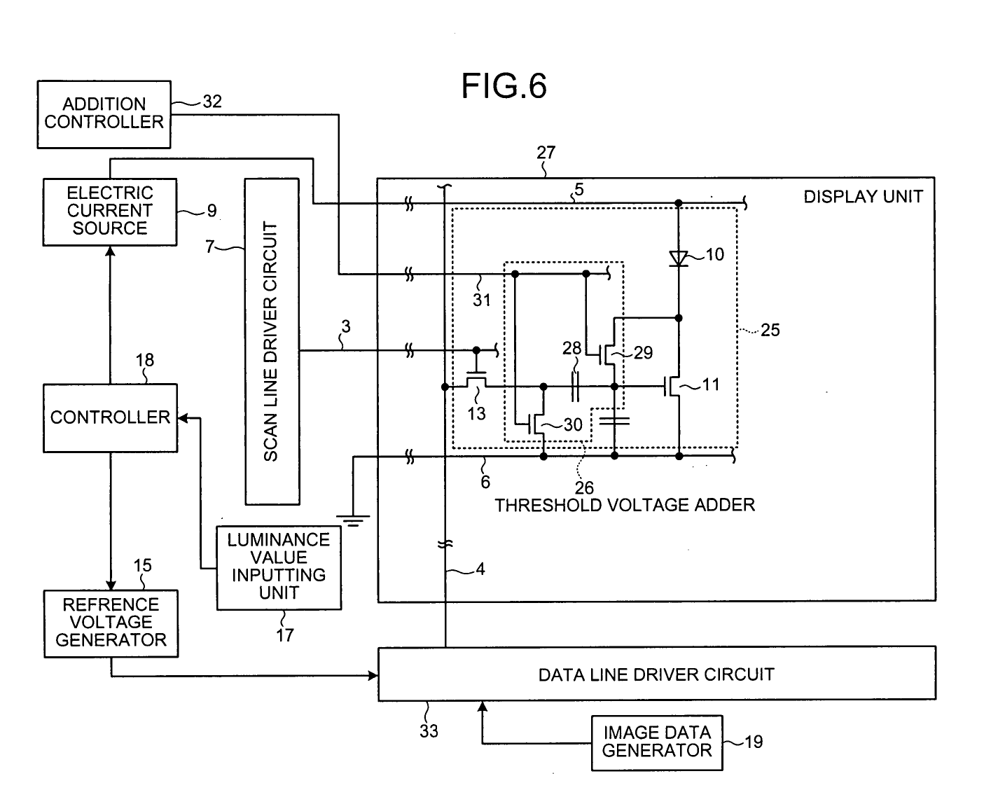

FIG. 6 is a schematic diagram showing an overall structure of the display according to the second embodiment. Plural pixel circuits 25 arranged in a matrix each include a threshold voltage adder 26 which detects a driving threshold voltage of the thin film transistor 11 functioning as a driver and adds detected driving threshold voltage to received data voltage to apply to the gate electrode of the thin film transistor 11.

The threshold voltage adder 26 includes a condenser 28 having a cathode connected to the gate electrode of the thin film transistor 11 and an anode connected to the source/drain electrode of the thin film transistor 13, a first switching element 29 which makes the gate and the drain of the thin film transistor 11 conduct as appropriate, and a second switching element 30 which makes an anode of the condenser 28 and the electric current discharging line 6 conduct as appropriate. Here, the first switching element 29 and the second switching element 30 are formed respectively with a thin film transistor and gate electrodes thereof are electrically connected to an addition controller 32 via a reset line 31. Further, since the threshold voltage adder 26 is newly provided, a data-line driver circuit 33 of the display according to the second embodiment generates and outputs only the data voltage corresponding to the image data supplied from the image data generator 19 based on the reference voltage generated by the reference voltage generator 15.

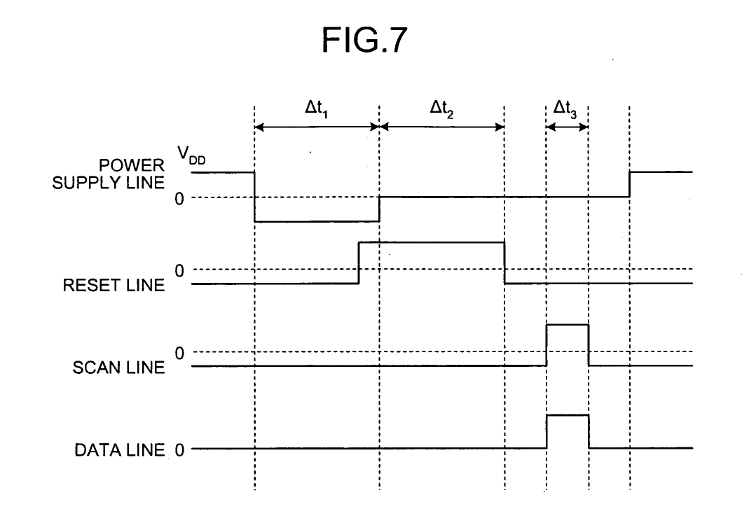

Voltage supply to the gate electrode of the thin film transistor 11 with the threshold voltage adder 26 is described. FIG. 7 is a timing chart showing fluctuation of potential in each of the power line 5, the reset line 31, the scan line 3, and the data line 4 in the display according to the second embodiment. Hereinbelow, the voltage supply is briefly described with reference to FIG. 7. In the following, it is assumed that the potential on the electric current discharging line 6 is maintained at zero and a predetermined level of voltage is applied to the gate electrode of the thin film transistor 11, whereby the thin film transistor 11 is driven in its initial state.

First, at time period Δt₁, the potential on the power supply line 5 attains a negative value and a voltage is applied to the electric current controlled light-emitting device 10 in a reverse direction from the direction at the time of light emission. Then, the electric current controlled light-emitting device 10 functions as a capacitance to accumulate electric charges corresponding to the potential difference between the electric current discharging line 6 and the power supply line 5. At time period Δt₁, the reset line 31, the scan line 3, and the data line 4 are maintained at a low potential, whereas the switching elements 29 and 30, and the thin film transistor 13 are suspended from being driven.

At time period Δt₂, the power supply line 5 attains a potential of zero, and the reset line 31 attains a potential equal to or higher than the driving threshold voltage of the switching elements 29 and 30. Thus, the switching elements 29 and 39 are driven to render the interconnection between the gate/drain of the thin film transistor 11 and the electric current discharging line 6, and the anode of the condenser 28 and the electric current discharging line 6 conductive. With the switching element 29 being driven and the electric current discharging line 6 attaining zero potential, the electric charges corresponding to the electric charges accumulated in the electric current controlled light-emitting device 10 and the voltage applied to the gate electrode of the thin film transistor 11 flow between the drain and the source of the thin film transistor 11 to be discharged through the electric current discharging line 6. On the other hand, with the discharge of the electric charges, the potential at the gate electrode of the thin film transistor 11 lowers. Then the potential difference between the gate and the source of the thin film transistor 11 lowers down to the driving threshold voltage at a certain point in the process of electric charge discharge, which stops with the suspension of the drive of the thin film transistor 11. Since the potential on the source electrode of the thin film transistor 11 is maintained at zero by the electric current discharging line 6, a voltage at a level equal to the driving threshold voltage remains on the gate electrode of the thin film transistor 11 (and on the cathode of the condenser 28 which is electrically connected to the gate electrode). Further, with the driving of the switching element 30 and the conduction between the anode of the condenser 28 and the electric current discharging line 6, the potential on the side of the anode of the condenser 28 attains a level equal to the potential on the electric current discharging line 6, i.e., zero.

Then, at time period Δt₃, the data voltage corresponding to the gradation level is written. In other words, with the potential on the scan line 3 changes to the value equal to or higher than the driving threshold voltage of the thin film transistor 13, the thin film transistor 13 is driven to render the data line 4 and the anode of the condenser 28 conductive. Further, at time period Δt₃, the potential on the reset line 31 lowers and the switching element 30 stops driving. Hence, the data voltage supplied from the data line 4 is supplied to the anode side of the condenser 28.

With the potential on the anode of the condenser 28 changes corresponding to the data voltage, the potential on the cathode of the condenser 28 also changes. In other words, as the potential on the reset line 31 lowers, the switching element 29 stops driving to render the cathode of the condenser 28 a floating state at time period Δt₃. Here, provided that the capacitance of the condenser 28 is large enough to allow ruling out of the capacitance of the condenser 12, in addition to the driving threshold voltage of the thin film transistor 11 applied in time period Δt₂, a voltage of a level equal to the data voltage is applied to the cathode of the condenser 28. With the process in time periods Δt₁-Δt₃, a sum of the data voltage corresponding to the gradation level and the driving threshold voltage of the thin film transistor 11 is supplied to the cathode of the condenser 28 and the gate electrode of the thin film transistor 11 connected to the cathode of the condenser 28.

In the display according to the second embodiment, the threshold voltage adder 26 is provided to each of the pixel circuits 25 arranged in the display unit 27. In addition, as is clear from the description about time period Δt₂ in FIG. 7, the driving threshold voltage can be detected according to the characteristics of the thin film transistor 11 provided in the pixel circuit 25. Hence, the display according to the second embodiment is advantageous in that the voltage can be supplied in accordance with the difference in the characteristics of the thin film transistor 11 in each of the pixel circuits 25 or the changes in driving threshold caused by the changes in the characteristics of the thin film transistor 11 over time in a single pixel circuit 25.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A display comprising:
an electric current controlled light-emitting device that emits light with a luminance depending on an electric current flowing therethrough;
a transistor that has a gate electrode, a source electrode, and a drain electrode, and controls the electric current based on a data voltage between one of the source and drain electrodes and the gate electrode; and
a controller that controls a voltage between the gate electrode and the source electrode and a voltage between the gate electrode and the drain electrode based on a change in the luminance of the electric current controlled light-emitting device while maintaining the transistor element in a saturation region.

2. The display according to claim 1, wherein
the controller controls the voltage between the gate electrode and the source electrode and the voltage between the gate electrode and the drain electrode so that a difference between the voltage between the gate electrode and the source electrode and a driving threshold voltage of the transistor is not more than a voltage between the drain electrode and the source electrode.

3. The display according to claim 1, further comprising:
an electric current source that outputs a predetermined level of electric current source voltage to supply the electric current to the electric current controlled light-emitting device;
a data voltage supplying unit that generates the data voltage corresponding to a gradation level based on a predetermined reference voltage; and
a reference voltage generating unit that generates a reference voltage corresponding to the luminance;
wherein the controller controls the electric current source voltage and the reference voltage to control the voltage between the gate electrode and the source electrode and the voltage between the gate electrode and the drain electrode.

4. The display according to claim 3, wherein
the controller controls the electric current source voltage and the reference voltage based on a standard electric current source voltage and a standard reference voltage, the standard electric current source voltage indicating the electric current source voltage where the transistor is in the saturation region with the electric current controlled light-emitting device emitting light with a predetermined standard display luminance, the standard reference voltage indicating a reference voltage where the transistor is in the saturation region with the electric current controlled light-emitting device emitting light with the predetermined standard display luminance.

5. The display according to claim 4, wherein
the electric current controlled light-emitting device has an anode electrically connected to the electric current source, and a cathode electrically connected to the drain of the transistor, and
the standard electric current source voltage and the standard reference voltage are determined so that a difference between the standard electric currents source voltage and a maximum voltage applied between the anode and the cathode is not less than the standard reference voltage.

6. The display according to claim 5, wherein
the controller derives the electric current source voltage as a sum of the standard electric current source voltage and a differential voltage according to the luminance, and derives the reference voltage as a sum of the standard reference voltage and a voltage obtained by division of the differential voltage by a circuit parameter determined based on a circuit structure around the transistor.

7. The display according to claim 1, further comprising:
a threshold voltage detecting unit that detects a driving threshold voltage of the transistor; wherein
a voltage corresponding to a sum of the data voltage and the driving threshold voltage is applied between the gate electrode and the source electrode of the transistor.
